(19) United States
(12) Patent Application Publication
(10) Pub. No.: US 2024/0428191 A1
(43) Pub. Date: Dec. 26, 2024

(54) SYSTEM AND METHODS FOR PERFORMING ORDER CART AUDITS

(71) Applicant: KoiReader Technologies, Inc., Dallas, TX (US)

(72) Inventors: Ashutosh Prasad, Dallas, TX (US); Vivek Prasad, Bengaluru (IN)

(21) Appl. No.: 18/702,631

(22) PCT Filed: Mar. 8, 2023
(86) PCT No.: PCT/US23/63930

§ 371 Date: Apr. 18, 2024

Related U.S. Application Data
(60) Provisional application No. 63/269,081, filed on Mar. 9, 2022.

(51) Int. Cl. G06Q 10/0875; G06Q 30/0601

(52) U.S. Cl. CPC G06Q 10/0875; G06Q 30/0633

(57) ABSTRACT

Techniques are described for automating and computerizing order cart audits to reduce the overall costs associated with shipping incorrect items, missing items, and/or additional items. In some cases, the system may be configured to perform an audit of a completed or filled order cart. The facility operator may pass the order cart through an audit area prior to loading the items on a vehicle for transport. During the audit, the system may capture sensor data associated with the order cart and identify each item present. The system may determine whether or not each item is part of the order and notify an operator accordingly.

### CROSS-REFERENCE TO RELATED APPLICATION(S)

This application is a U.S. national stage application under 35 USC §371 of International Application No. PCT/US23/63930 filed on Mar. 8, 2023 and entitled “SYSTEM AND METHODS FOR PERFORMING ORDER CART AUDITS,” which claims priority to U.S. Provisional Application No. 63/269,081 filed on Mar. 9, 2022 the entire contents of which are incorporated herein by reference.

### BACKGROUND

Storage facilities, such as shipping yards, processing plants, warehouses, distribution centers, ports, yards, and the like, may store vast quantities of inventory over a period of time. Facility operators often generate shipments of various different inventory items. Unfortunately, shipments often contain missing items, wrong items, additional items, and the like resulting in unnecessary costs associated with lost item claims, returns, and unnecessary restocking.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of a facility utilizing an audit system for performing order cart review prior to loading of transport vehicles, according to some implementations.

FIG. 2 is an example block diagram of the audit system of FIG. 1, according to some implementations.

FIG. 3 is an example pictorial view of an order cart divided into regions by the audit system of FIG. 1, according to some implementations.

FIG. 4 is an example pictorial view of an item having multiple identifiers, according to some implementations.

FIG. 5 is an example pictorial view of an item having multiple identifiers, according to some implementations.

FIG. 6 is a flow diagram illustrating an example process associated with auditing an order cart, according to some implementations.

FIG. 7 is another flow diagram illustrating an example process associated with auditing an order cart, according to some implementations.

FIG. 8 is another flow diagram illustrating an example process associated with auditing an order cart, according to some implementations.

FIG. 9 is another flow diagram illustrating an example process associated with auditing an order cart, according to some implementations.

FIG. 10 is another flow diagram illustrating an example process associated with auditing an order cart, according to some implementations.

FIG. 11 is another flow diagram illustrating an example process associated with auditing an order cart, according to some implementations.

FIG. 12 is another flow diagram illustrating an example process associated with auditing an order cart, according to some implementations.

FIG. 13 is another flow diagram illustrating an example process associated with auditing an order cart, according to some implementations.

FIG. 14 is an example audit system that may implement the techniques described herein according to some implementations.

### DETAILED DESCRIPTION

Discussed herein are systems and devices for automating and computerizing the order cart audits to reduce the overall costs associated with shipping incorrect items, missing items, and/or additional items. As discussed herein, an order cart may include but is not limited to a cart (either manual or automated), a pallet or other transport handling unit, processing or facility containers, and the like. In some storage facilities, facility operators may receive orders to be filled. The orders may contain various items of differing quantities. In order to fulfill the orders, one or more facility operator and/or an autonomous system may navigate a cart or other container through the facility and select or pick items associated with the order by placing the items from shelving or storage into the cart or container. In many situations, the facility operator may scan a bar code or other identifier on the exterior of the item or the items packaging as the item is placed in the order cart to record the pick event. Conventional order cart audit systems may then confirm the scanned identifier or bar code matches the corresponding item on the order list.

Unfortunately, mistakes associated with scanning and picking items for the order cart may occur from time to time. For example, an item may not be labeled with a scannable identifier and, thus, as the item is picked, the item cannot be verified by the conventional audit system. In this example, a facility operator may scan an identifier associated with the shelving, but the item may be incorrectly placed. As such, the wrong item may be placed on the order cart. In other examples, an item may include multiple identifiers (such as a reused carton, box, container, or the like). In this example, even if the facility operator scans the correct identifier and the correct item is shipped, it is common for the receiving facility or customer to scan the wrong identifier and mistakenly return the item resulting in increased shipping costs, restocking fees, and delivery delays.

In some examples, the system, discussed herein, is configured to audit the order cart in lieu of or in addition to the operators scanning of the item identifiers. For instance, the system, discussed herein, may be configured to perform an audit of a completed order cart. In this instance, the facility operator may pass the order cart through an audit area prior to loading the items on a vehicle for transport. During the audit, the system may capture sensor data associated with the order cart. The system may then, based at least in part on the sensor data, identify each item present on the order cart. The system may also determine whether or not each item is part of the order. If the order is correct (e.g., each expected item is present and no additional items are present), the system may alert the facility operator to proceed with loading the transport vehicle. However, if the order is incorrect (e.g., the cart is missing items or contains wrong items or additional items), the system may alert the facility operator to proceed to a triage area prior to loading the transport vehicle.

At the triage area, the system may include a display or user interface (e.g., a display at the triage area, a display associated with a device of the operator, and/or the like). The system may present a model of the order cart and each item on the cart.

In some cases, the model may be a three-dimensional model of the order cart and each item present on the order in other cases the model may be a two-dimensional (such as an overhead model) of the order cart and each item present on the order cart. The system may highlight (e.g., color, circle, or otherwise distinguish) the incorrect items (e.g., wrong items, additional items, or the like) on the order cart, such that the operator may quickly identify the item, the location of the item, and remove the item from the order cart. The system may then present the operator with a list of missing items and instructions to re-pick the missing items.

In some examples, the model may also include stacking instructions associated with loading the transport vehicle. For example, the system may generate instructions on how to arrange the items within the transport, on a transport handling unit (THU), or the like. In some cases, the instructions may include merging the order with other orders associated with the same customer or destination. As discussed herein, a THU may include, but is not limited to, as pallets, bins, unit load devices (ULDs), ocean containers, airfreight units, any object that may carry or otherwise transport an inventory item, and the like.

In some cases, the system may also determine, based at least in part on the sensor data, if each item has only correct labels visible or scannable. For example, if the item contains multiple visible identifiers or labels, the system may alert the facility operator to proceed to the triage area even if all the items are correct. In some cases, when an item has multiple identifiers, the system may determine the correct identity of the item, based on the sensor data and one or more item models, and/or based on an analysis of the labels to determine which label is on top or newest. Once the correct identity is known, the system may determine if the item is the correct item or an incorrectly labeled item. In the latter case, the system may cause the facility operator to remove the item and replace (e.g. repick) with the correct item via the cart model and display, as discussed above. In the former case, the system may cause one or more new labels to print at a printer associated with the system and the triage area. The label may include a new identifier associated with the correct item. The system may then cause the display to present the item, the location of the item and instructions (such as a visual representation) of where to the place the one or more new labels on the item. Once the labels are applied the system may rescan the item to determine that the new labels are correctly placed to prevent inadvertent scanning of an incorrect label upon delivery by the receiving party or customer.

In some examples, items identifiers may be blocked from view when the system captures the sensor data. In these cases, the system may attempt to identify the item via the sensor data and one or more item models. If the system is still unable to confirm the identity of the item, the system may direct the operator to the triage area in which the user may manually, via a user device, scan the identifier on the blocked item. In other cases, the system may cause instructions to reorganize the order cart to be displayed to the operator and the system may rescan the order cart upon a completion of the reordering by the operator.

In some examples, the system may detect an order cart entering or positioned within the audit area. The system may receive first sensor data associated with the entire cart from the one or more sensors. The system may then, based at least in part on the first sensor data, partition the order cart into two or more discretized regions. The system may then cause the sensors to capture second sensor data for each region. For example, the sensors may include a pan, title, and/or zoom features, such that one sensor may adjust and/or zoom to capture the second sensor data for each region as a separate data set.

The system may then determine if any items associated with the order cart are associated with two or more regions. The system may then assign each item in two or more regions to a single region, based at least in part on the second sensor data for each region. The system may then identify each item based on the second sensor data and compare the identified items to the order list, as discussed above.

In some examples, the audit system may utilize one or more heuristic and/or one or more machine learned models to assist with identifying items, determining correct identifiers, and distinguishing between unlabeled items. Details associated with identifying items, identifiers, and the like are discussed in U.S. Provisional Patent Application No. 63/263,417, which is herein incorporated by reference in its entirety for all purposes. As one illustrative example, the audit system may utilize one or more machine learned models to perform segmentation and classification for individual items associated with the order cart.

In some examples, one or more sensors may be associated with the audit system to generate the sensor data, such as positioned with respect to an audit area and/or triage area, as discussed above. The sensors may include one or more internet of things (IoT) devices. The IoT computing devices may include a smart network video recorder (NVR) or other type of EDGE computing device with a GPU/NPU/CPU. Each IoT device may also be equipped with sensors and/or image capture devices, such as visible light image systems, infrared image systems, other image based devices, radar based systems, LIDAR based image systems, SWIR based image systems, Muon based image systems, radio wave based image systems, and/or the like. In some cases, the IoT computing devices may also be equipped with models and instructions to capture, parse, identify, and extract information associated with a lifecycle of an asset, as discussed herein, in lieu of or in addition to the cloud-based services. For example, the IoT computing devices and/or the cloud-based services may be configured to perform segmentation, classification, attribute detection, recognition, data extraction, and the like.

As described herein, the machine learned models may be generated using various machine learning techniques. For example, the models may be generated using one or more neural network(s). A neural network may be a biologically inspired algorithm or technique which passes input data (e.g., image and sensor data captured by the IoT computing devices) through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from the captured sensor and/or image data. In some cases, the neural network may be a trained network architecture that is end-to-end. In one example, the machine learned models may include segmenting and/or classifying extracted deep convolutional features of the sensor and/or image data into semantic data. In some cases, appropriate truth outputs of the model in the form of semantic per-pixel classifications (e.g., vehicle identifier, container identifier, driver identifier, and the like).

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions, color analyzing or processing techniques and/or a combination thereof.

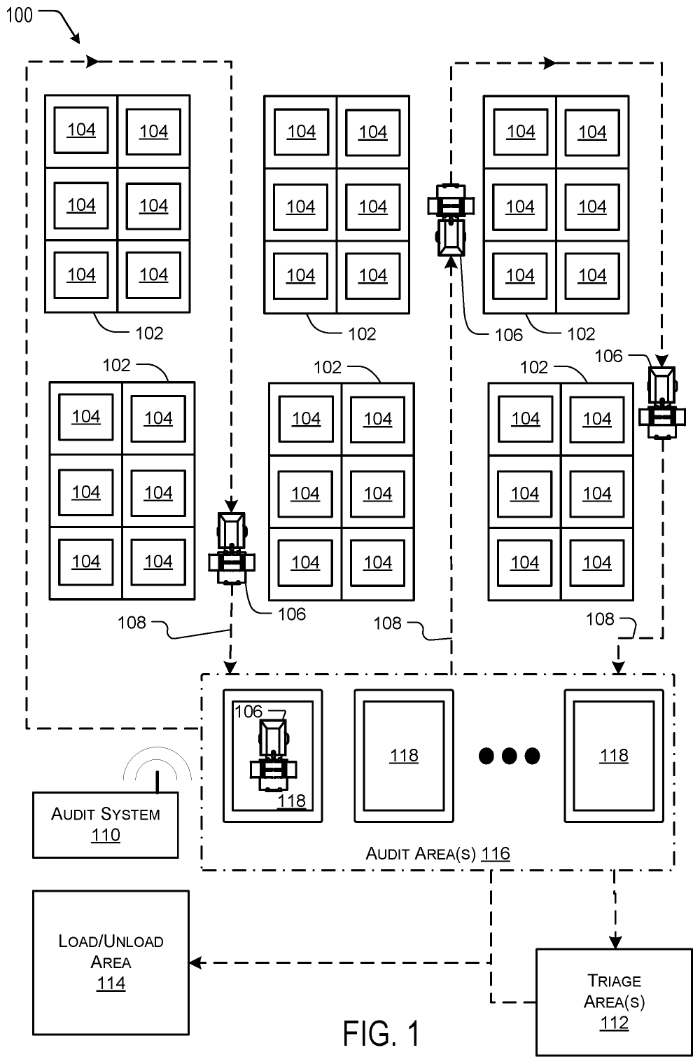

FIG. 1 is an example block diagram of a facility 100 utilizing an audit system 110 for performing order cart 106 review prior to loading of transport vehicles, according to some implementations. As illustrated, the facility may include a number of shelves 104 within a storage area, generally indicated by 104. One or more order carts 106 may traverse the facility 100 including the storage areas 102 along routes 108 (such as either via a facility operator and/or as an autonomous system). As the items are retrieved or picked from the shelves 104, the facility operator may scan or otherwise input identifiers associated with the items into the audit system 110, such as via a user or handheld device.

Once the order has been picked, the order cart 106 may navigate to an audit area 116. The audit area 116 may be equipped with one or more sensors as discussed above. In some cases, the audit area 116 may include two or more audit pads 118, such that multiple order carts 106 may be audited substantially simultaneously. At the audit area 116, the sensors may capture sensor data which is provided to the audit system 110. The audit system may then detect each item and an associated identifier based at least in part on the sensor data, one or more item models, and/or the order list. If the order is complete (e.g., all of the expected items are present and no additional items are present), the audit system 110 may provide instructions, via one or more display associated with the audit pad 118 and/or the user device of the cart operator, to proceed to the load/unload area 114, such that the order may be shipped.

If the order is not correct (e.g., one or more expected item is missing and/or an additional item is present), the audit system 110 may direct the cart operator to proceed to the triage area 112. At the triage area 112, the audit system 110 may present a model of the order cart highlighting the incorrect items and/or a list of missing items. In this manner, the operator may quickly identify the additional items and remove them and/or return the storage area 102 and pick the missing items. While the current example illustrates the triage area 112 in some implementations the audit area 118 and the triage aera 112 may be combined or one area may server both purposes.

In some cases, if an item has identifier issues, the audit system 110 may also direct the cart to the triage area 112. In these cases, the audit system 110 may present to the operator the model of the cart, indicating the items with missing, multiple, or confusing labels/identifiers again for the operator to quickly identify the item. The system 110 may also cause one or more new labels/identifiers to print and include instructions to cover or replace the existing identifiers prior to proceeding to the load/unload area 114. In some cases, the system 110 may also request the operator to manually scan, via the user device, one or more identifiers to confirm the identity and correct labeling of an item prior to proceeding to the load/unload area 114.

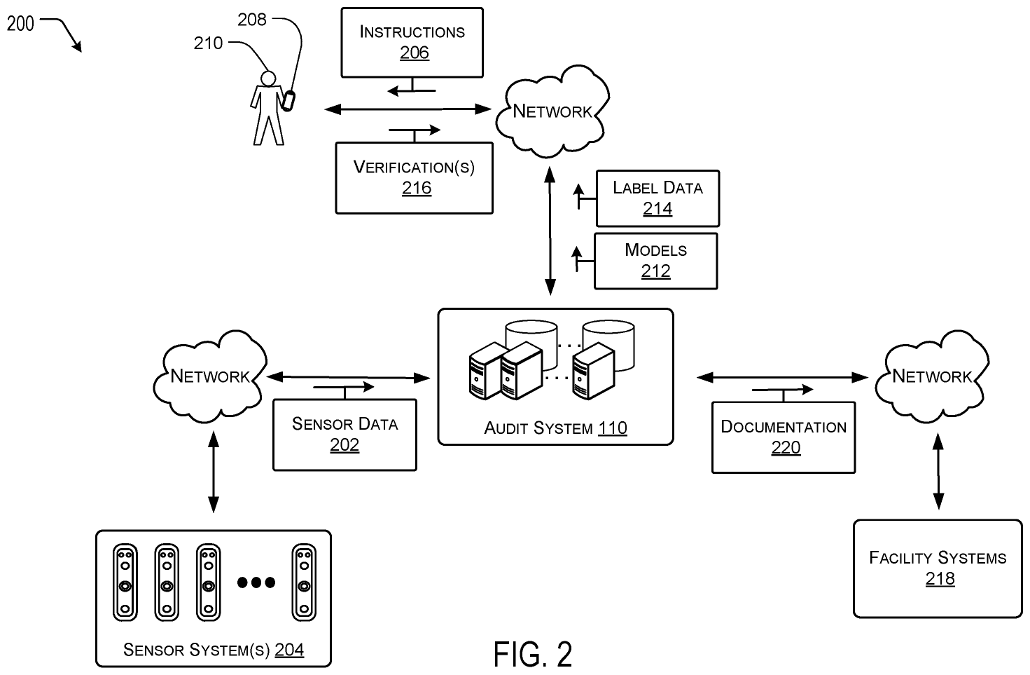

FIG. 2 is an example block diagram of the audit system 110 of FIG. 1, according to some implementations. In the current example, the audit system 110 may receive sensor data 202 from one or more sensors 204 associated with the audit area of the facility as discussed above. The audit system 110 may then detect each item and an associated identifier based at least in part on the sensor data 202, one or more item models, and/or the order list. If the order is complete (e.g., all of the expected items are present and no additional items are present), the audit system 110 may provide instructions 206, via one or more displays associated with the audit pad and/or a user device 208 of the cart operator 210, to proceed to the load/unload area 114, such that the order may be shipped.

If the order is not correct (e.g., one or more expected item is missing and/or an additional item is present), the audit system 110 may direct the cart operator to proceed to the triage area via, for example, instructions 206 via one or more displays associated with the user device 208. At the triage area, the audit system 110 may present a model 212 of the order cart highlighting the incorrect items and/or a list of missing items. In this manner, the operator may quickly identify the additional items and remove them and/or return the storage area and pick the missing items.

In some cases, if an item has identifier issues, the audit system 110 may also direct the operator 210 to the triage area again via the instructions 206. In these cases, the audit system 110 may present to the operator the model 212 of the cart indicating the items with missing, multiple, or confusing labels/identifiers again for the operator to quickly identify the item. The system 110 may also send label data 214 to the triage area to cause one or more new labels/identifiers to print and include instructions 206 to cover or replace the existing identifiers prior to proceeding to the load/unload area. In some cases, the system 110 may also request the operator to manually scan or provide verification data 216 via the user device 208 for one or more identifiers to confirm the identity and correct labeling of an item prior to proceeding to the load/unload area.

In this example, the audit system 110 may also provide documentation 220 and/or reports to other facility systems 218 or operators such as a gate checkout location (e.g., check out information), the load or unload area (e.g., an all-clear signal), and the like.

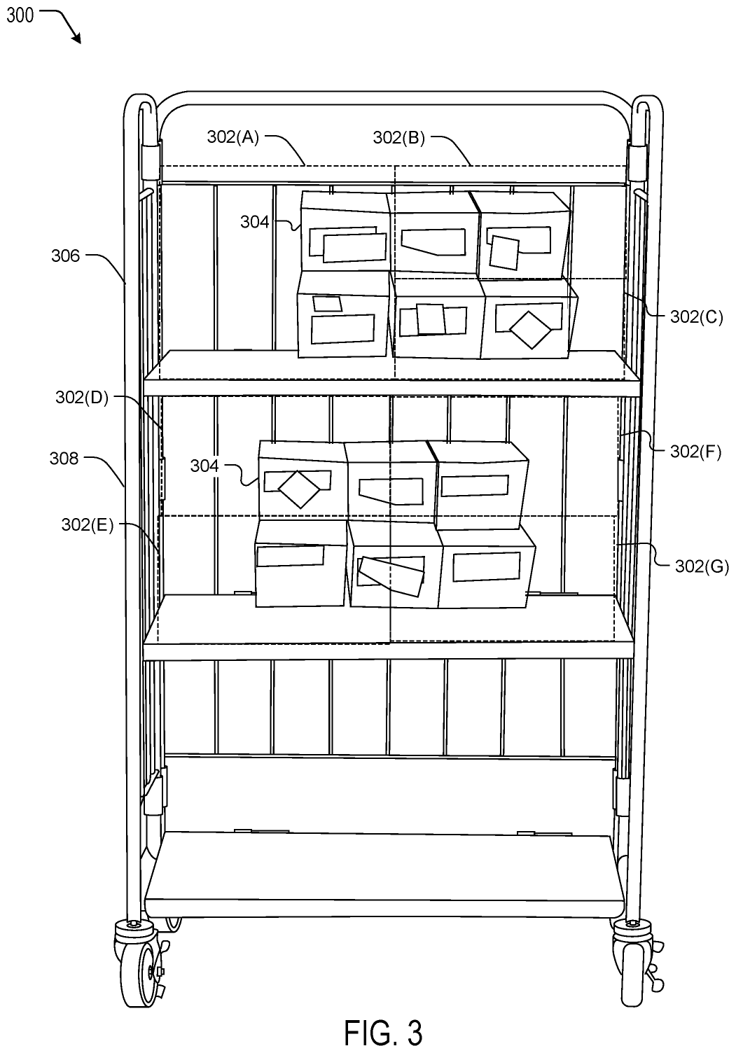

FIG. 3 is an example pictorial view of an order cart 300 divided into regions 302(A)-302(G) by the audit system of FIG. 1, according to some implementations. In this example, two of the levels of the order cart 300 include items, generally indicated by 304. As illustrated, as the cart 300 enters the audit area the sensor data of the cart 300 and the items 304 are captured. In this example, the cart 300 may be divided into regions 302(A)-(G) that may be captured individually or partitioned/segmented from the sensor data to be processed individually. In some cases, the items 304 may be within two or more regions 302. In these cases, the audit system may determine a region and assign the item to the determined region 302, for instance, based on an amount of the item 304 within each region 302 and/or the location of a label or an amount of the label within one or both of the regions.

In this example, the top shelf 306 of the cart 300 is divided into three regions 302(A)-302(C). For instance, the regions may be selected based on a number of items 304 detected within each region. Likewise, the second shelf or middle shelf 308 of the cart 300 is divided into four equal regions 302(D)-(G). Thus, it should be understood, that the cart 300 may be divided into irregular or regular regions as well as regions defined by the number of items, size of the items, visibility of the items to the field of view of the sensors, number of sensors, size of the cart 300, and the like.

Additionally, this example is illustrated from a side perspective. In some cases, the partition and sensors field of view may be a top down perspective. However, it should be understood, that the cart may be partitioned using a top down perspective as well as or in lieu of the side based perspective depending on cart design, type, and size.

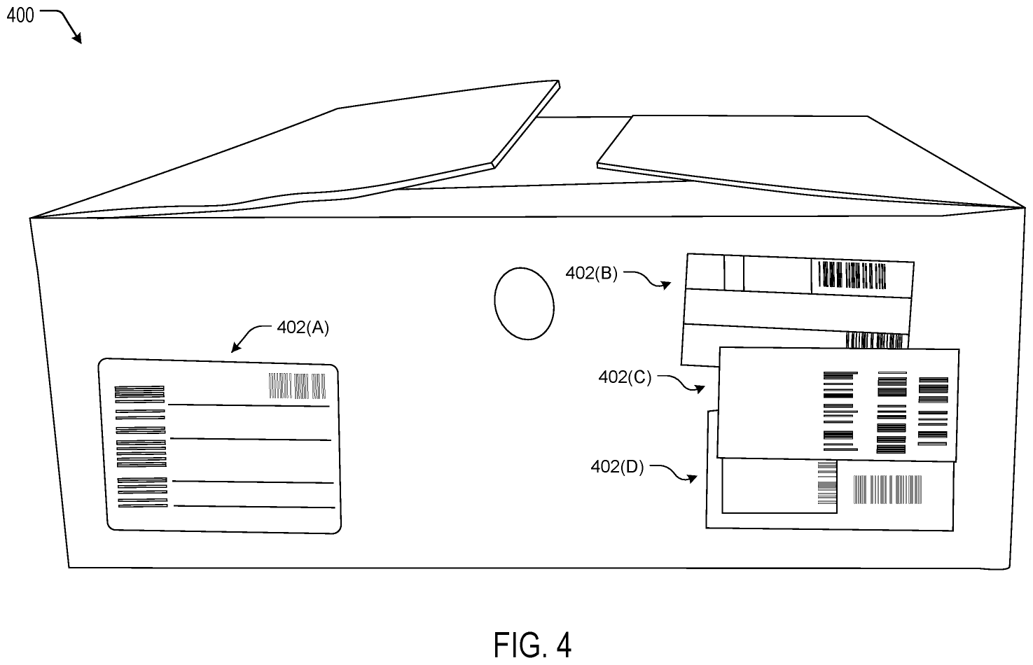

FIG. 4 is an example pictorial view of an item 400 having multiple identifiers 402(A)-402(D), according to some implementations. As discussed above, the audit system may determine which label is correct and in some cases cause a printer to generate new labels to cover one or more of the existing labels 402(A)-(D) to thereby prevent an inadvertent scanning of the wrong label upon delivery of the item and, accordingly, a return of a correctly delivered item. In this example, the system may detect that the labels 402(B) and 402(D) are under label 402(C). Accordingly, the system may determine that the labels 402(B) and 402(D) are old or associated with another item shipped within the same packaging, such as a prior shipment.

In some cases, such as the one illustrated, two labels 402(A) and 402(C) may be on overlapping. In these cases, the system may determine the identity associated with each label 402(A) and 402(C). The system may also classify the item and/or packaging 400 via one or more machine learned models. The system may then determine if either label 402(A) or 402(C) match the classification. In some case, if the system is unable to identify the correct label 302(A) or 402(C), the system may instruct an operator to perform a manual inspection and scanning of the correct label. For instance, the operator may remove the items 400 from the packaging determine the identity and the correct label 402(A) or 402(C) by scanning and confirming via a user device.

Once the correct label is determined, the system may cause new labels to print and provide instructions to the operator to place the new labels over the labels 402(A), 402(B), 402(C) and/or 402(D). In some examples, the system may capture sensor data associated with the placement of the new labels or the item 400 after the labels are placed, such that the system may confirm the correct placement prior to shipping.

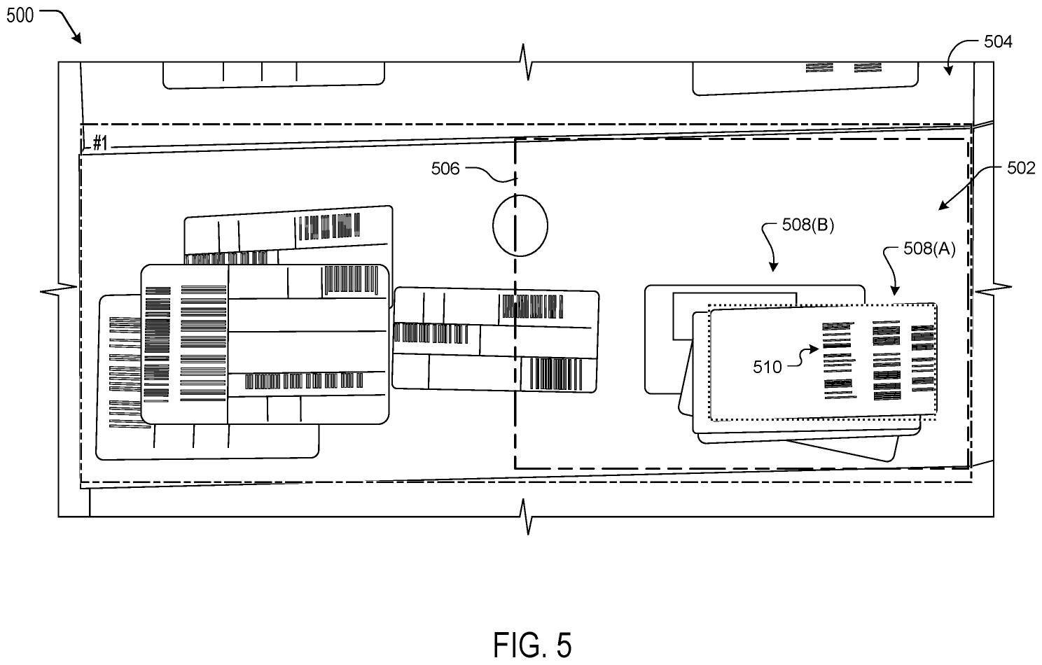

FIG. 5 is an example pictorial view 500 of an item having multiple identifiers, according to some implementations. As discussed above, the audit system may determine which label is correct in order to read the correct identifiers for the item 502. In this example, the system may detect the item 502 from multiple items, such as in the example, if another item 504 is stacked atop the item 502.

The system may also segment the item 502 into regions, such as a left region and right region or top region and bottom region, based on customer or shipper data associated with where to expect the label. In this example, the system may select the right region 506 as the region that includes the correct identifier based at least in part on the customer data.

In this example, the region 506 still includes multiple labels, such as the labels 508(A) and 508(B). In some examples, the system may identify the top label, e.g., label 508(A), as the correct label based on its position relative to other labels, such as label 508(B). The system may also utilize the multiple identifiers, generally indicated by 510, on the label 508(A) together with text or other content on the item 502 to determine the identity of the item 502. For example, the multiple identifiers 510 may include overlapping portions that can be verified with each other to confirm the identity of the item 502 or that each identifier belongs to the same label. In some cases, the label 508(A) may also include text, such as checksums, that can be used to validate the identifiers 510 as current, correct, and/or accurate.

In one example, one or more of the identifiers 510 may be damaged or obstructed. In these cases, the system may utilize the data from any remaining scannable portion of the damaged identifier 510, the order list, the other identifiers 510, and/or text/images on the item 502 to identity the item and/or determine the content of the damaged identifier 510.

In some cases, the system may also classify the item and/or packaging 502 via one or more machine learned models. The system may then determine if either label 508(A) and 508(B) matches the classification. In some case, if the system is unable to identify the correct label 508(A) and 508(B), the system may instruct an operator to perform a manual inspection and scanning of the correct label. For instance, the operator may remove the items 502 from the packaging determine the identity and the correct label 508(A) and 508(B) by scanning and confirming via a user device.

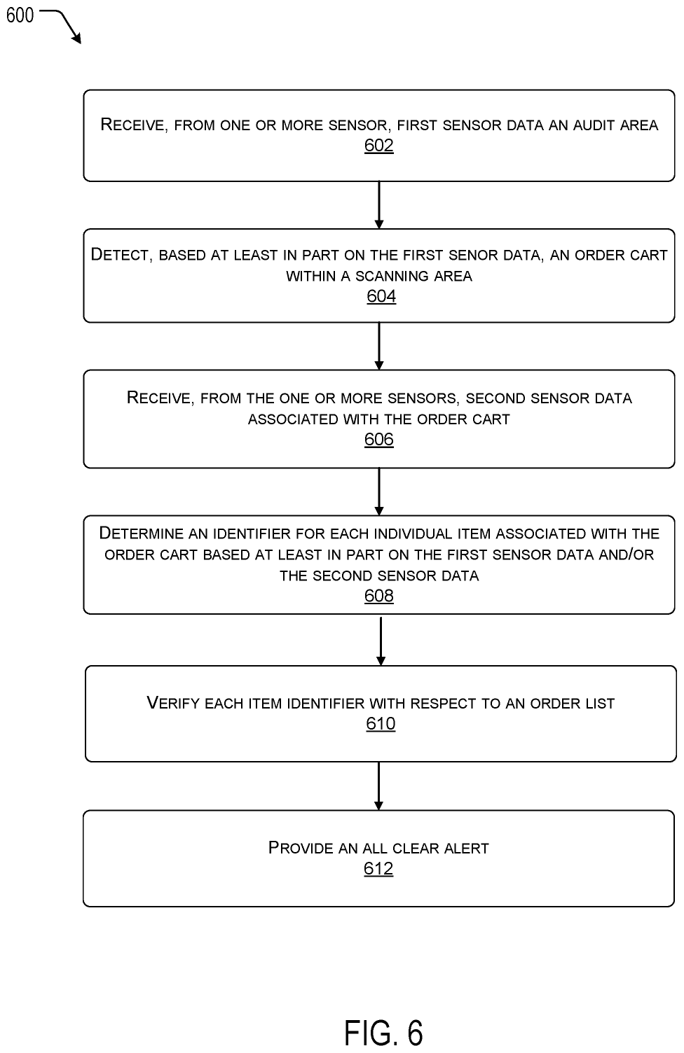

FIGS. 6-13 are flow diagrams illustrating example processes associated with the audit systems discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processor(s), perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 6 is a flow diagram illustrating an example process 600 associated with auditing an order cart, according to some implementations. In the current example, an order cart may be placed within or passed through an audit area. The system may capture sensor data via one or more sensors of the order cart and any items located thereupon.

At 602, the system may receive, from one or more sensors, first sensor data associated with an audit area. For example, the sensor data may be image data of an order cart and/or the individual items current located on the order cart that is placed within the audit area. In some cases, the sensor data may include depth data, weight data (e.g., a floor sensor detecting the weight of the order cart), contact data (e.g., a wheel of a cart contacting a floor sensor).

At 604, the system may detect an order cart within a scanning area. For example, the system may utilize the first sensor data to determine that a cart is present in the audit area.

At 606, the system may receive, from the one or more sensors, second sensor data associated with the order cart. In one example, the second sensor data may be image data captured by one or more sensors associated with a partition of the order cart, as discussed above. As an illustrative example, the second sensor data may include data associated with each individual package or two or more defined regions associated with the order cart. In some cases, the system may determine the regions assisted with the second sensor data based at least in part on the first sensor data. For instance, the system may determine features of the cart, such as a size, type, class or the like of the order cart, as well as features of the items, such as size, number, position, class, type of the items on the cart. The system may then determine the regions based on the features of the cart and/or the items. In some cases, the second sensor data may include a partition of the first sensor data into data associated with individual items or packages, such as a segmentation of an image into smaller sections.

At 608, the system may determine an identifier for each individual item associated with the order cart based at least in part on the first sensor data and/or the second sensor data. For example, the system may determine the identity of each item by detecting a label or other identifier on each item within the first sensor data and/or the second sensor data.

At 610, the system may verify each item identifier with respect to an order list. For example, the system may compare each detected identifier with an expected identifier on the order list associated with the order cart. In some cases, the system may utilize a detected identifier on the order cart to select the order list from a plurality of orders being filled by facility operators and/or systems.

At 612, the system may provide an all clear alert to the operator. For example, the system may verify each of the items with the order list and if the order is complete and correct (e.g., no missing items, no additional items, and all items have a correct label or identifier), the system may provide to a user device associated with the operator of the order cart and/or display associated with the audit area a notification or alert that the operator may proceed to load the items onto a transport vehicle for delivery.

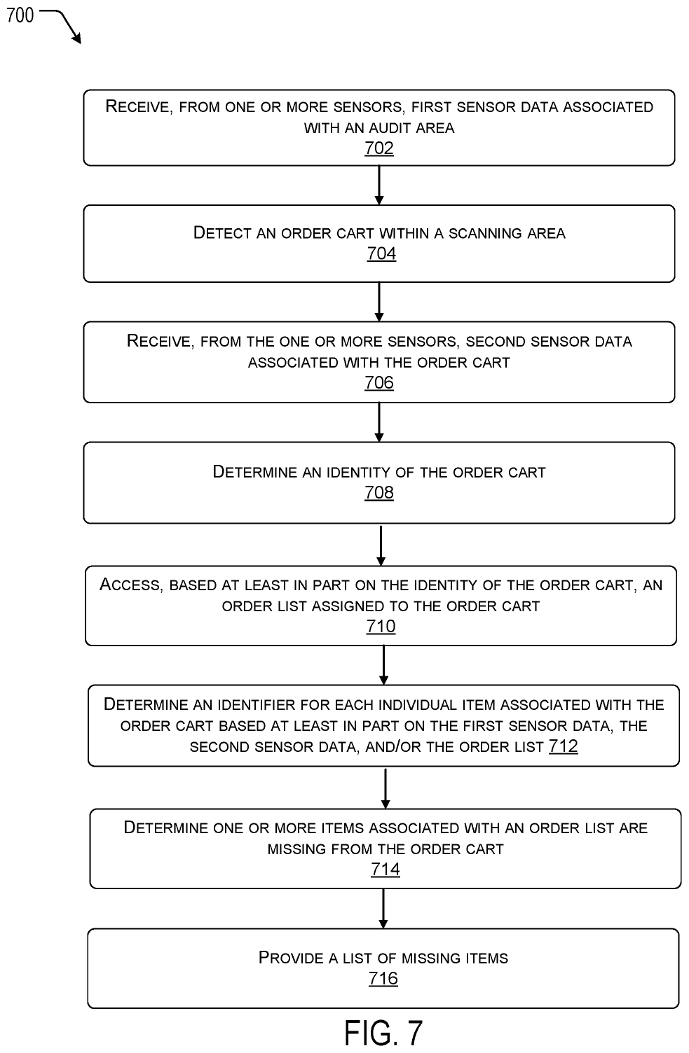

FIG. 7 is another flow diagram illustrating an example process 600 associated with auditing an order cart, according to some implementations. In the current example, an order cart may be placed within or passed through an audit area. The system may capture sensor data via one or more sensors of the order cart and any items located thereupon.

At 702, the system may receive, from one or more sensors, first sensor data associated with an audit area. For example, the sensor data may be image data of an order cart and/or the individual items current located on the order cart that is placed within the audit area. In some cases, the sensor data may include depth data, weight data (e.g., a floor sensor detecting the weight of the order cart), contact data (e.g., a wheel of a cart contacting a floor sensor).

At 704, the system may detect an order cart within a scanning area. For example, the system may utilize the first sensor data to determine that a cart is present in the audit area.

At 706, the system may receive, from the one or more sensors, second sensor data associated with the order cart. In one example, the second sensor data may be image data captured by one or more sensors associated with a partition of the order cart, as discussed above. As an illustrative example, the second sensor data may include data associated with each individual package or two or more defined regions associated with the order cart. In some cases, the system may determine the regions assisted with the second sensor data based at least in part on the first sensor data. For instance, the system may determine features of the cart, such as a size, type, class or the like of the order cart, as well as features of the items, such as size, number, position, class, type, of the items on the cart. The system may then determine the regions based on the features of the cart and/or the items. In some cases, the second sensor data may include a partition of the first sensor data into data associated with individual items or packages, such as a segmentation of an image into smaller sections.

At 708, the system may determine the identity of the order cart. For example, the order cart may include a cart identifier or other visual indication (such as color, strips, alpha-numerical characters, scannable code, or the like) and the system may determine the identity by detecting the identifier within the first sensor data and/or the second sensor data. In other cases, the system may determine the identity based on a wireless signal transmitted by the order cart, the presence of an assigned facility operator (e.g., biometric identity, employee badge, proximity of a device associated with an assigned operator, or the like), a user input of an identifier at a device associated with the scanning area, or the like.

At 710, the system may access data associated with an order list assigned to the order cart. For example, the system may access a datastore that includes details or item information for each item that is assigned to an order.

At 712, the system may determine an identifier for each individual item associated with the order cart based at least in part on the first sensor data, the second sensor data, and/or the order list. For example, the system may determine the identity of each item by detecting a label or other identifier on each item within the first sensor data and/or the second sensor data and compare the identifiers to identifier of the order list.

At 714, the system may determine one or more items associated with an order list are missing from the order cart. For example, the system may compare the items identified with respect to the order cart to one or more identifier within the order list. In some cases, the system may also determine a number of items on the order cart is less than an expected number.

At 716, the system may provide a list of missing items to an operator of the order cart. For example, the list may be provided via a user device associated with the operator and/or via a display associated with the audit area.

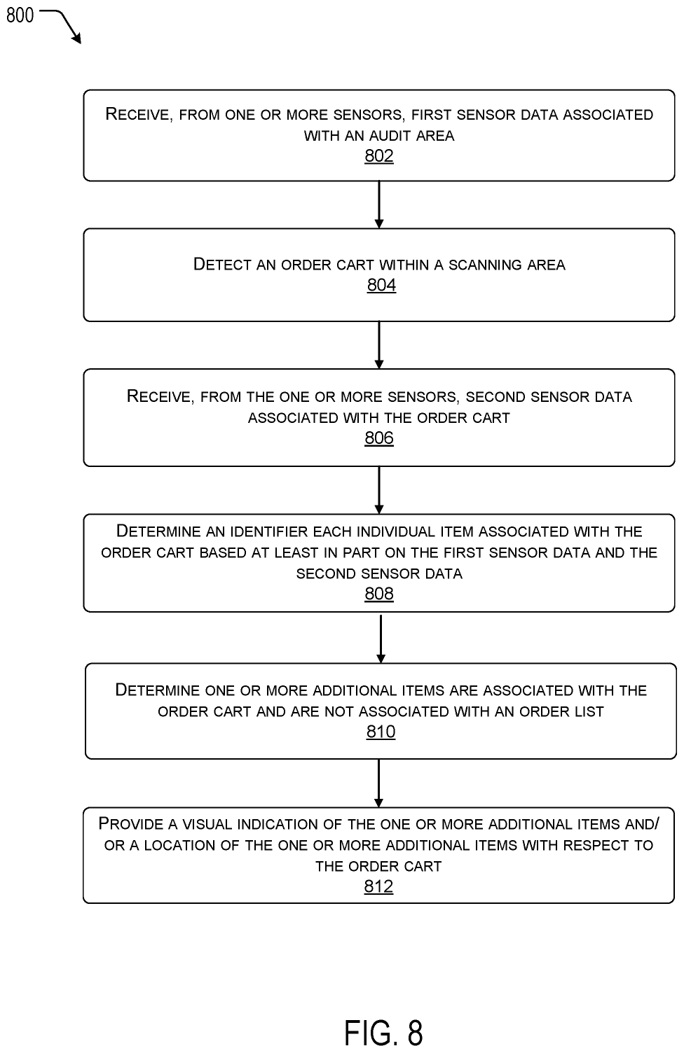

FIG. 8 is another flow diagram illustrating an example process 700 associated with auditing an order cart, according to some implementations. In the current example, an order cart may be placed within or passed through an audit area. The system may capture sensor data via one or more sensors of the order cart and any items located thereupon.

At 802, the system may receive, from one or more sensors, first sensor data associated with an audit area. For example, the sensor data may be image data of an order cart and/or the individual items current located on the order cart that is placed within the audit area. In some cases, the sensor data may include depth data, weight data (e.g., a floor sensor detecting the weight of the order cart), contact data (e.g., a wheel of a cart contacting a floor sensor).

At 804, the system may detect an order cart within a scanning area. For example, the system may utilize the first sensor data to determine that a cart is present in the audit area.

At 806, the system may receive, from the one or more sensors, second sensor data associated with the order cart. In one example, the second sensor data may be image data captured by one or more sensors associated with a partition of the order cart, as discussed above. As an illustrative example, the second sensor data may include data associated with each individual package or two or more defined regions associated with the order cart. In some cases, the system may determine the regions assisted with the second sensor data based at least in part on the first sensor data. For instance, the system may determine features of the cart, such as a size, type, class or the like of the order cart, as well as features of the items, such as size, number, position, class, type, of the items on the cart. The system may then determine the regions based on the features of the cart and/or the items. In some cases, the second sensor data may include a partition of the first sensor data into data associated with individual items or packages, such as a segmentation of an image into smaller sections.

At 808, the system may determine an identifier for each individual item associated with the order cart based at least in part on the first sensor data and/or the second sensor data. For example, the system may determine the identity of each item by detecting a label or other identifier on each item within the first sensor data and/or the second sensor data.

At 810, the system may determine one or more additional items are associated with the order cart and are not associated with the order list. For example, the system may compare the items identified with respect to the order cart to one or more identifier within the order list. In some cases, the system may also determine a number of items on the order cart is more than an expected number.

At 812, the system may provide a visual indication of the one or more additional items and/or a location of the one or more additional items with respect to the order cart. For example, the system may generate a model of the order cart and the items currently associated with the order cart based at least in part on the first and/or second image data. The system may highlight the additional item within the model and present the model and the highlighted item on a display (e.g., a display associated with the audit area, a triage area, and/or a user device).

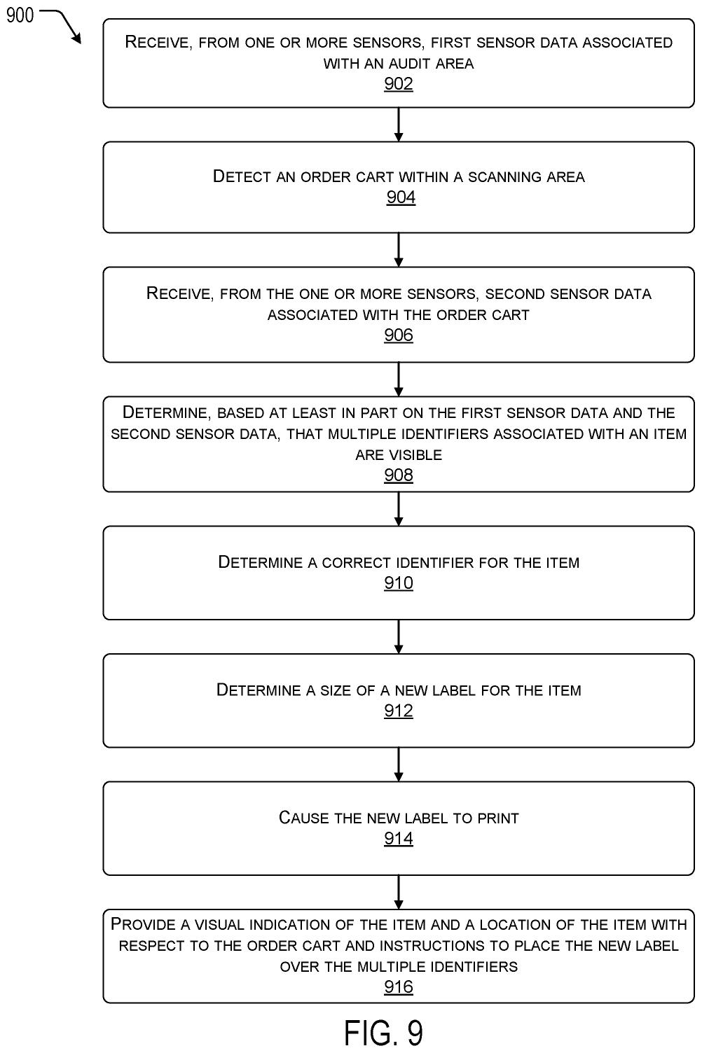

FIG. 9 is another flow diagram illustrating an example process 800 associated with auditing an order cart, according to some implementations. In the current example, an order cart may be placed within or passed through an audit area. The system may capture sensor data via one or more sensors of the order cart and any items located thereupon.

At 902, the system may receive, from one or more sensors, first sensor data associated with an audit area. For example, the sensor data may be image data of an order cart and/or the individual items current located on the order cart that is placed within the audit area. In some cases, the sensor data may include depth data, weight data (e.g., a floor sensor detecting the weight of the order cart), contact data (e.g., a wheel of a cart contacting a floor sensor).

At 904, the system may detect an order cart within a scanning area. For example, the system may utilize the first sensor data to determine that a cart is present in the audit area. In some cases, the system may also utilize the first sensor data to determine an orientation of each item (or package of items) on the cart. For example, the system may utilize one or more models, such as machine learned models, to determine the orientation of individual item. The system may then utilize the orientation in assisting with determining or understanding correlations of labels or label data to items.

At 906, the system may receive, from the one or more sensors, second sensor data associated with the order cart. In one example, the second sensor data may be image data captured by one or more sensors associated with a partition of the order cart, as discussed above. As an illustrative example, the second sensor data may include data associated with each individual package or two or more defined regions associated with the order cart. In some cases, the system may determine the regions assisted with the second sensor data based at least in part on the first sensor data. For instance, the system may determine features of the cart, such as a size, type, class or the like of the order cart, as well as features of the items, such as size, number, position, class, type, of the items on the cart. The system may then determine the regions based on the features of the cart and/or the items. In some cases, the second sensor data may include a partition of the first sensor data into data associated with individual items or packages, such as a segmentation of an image into smaller sections.

At 908, the system may determine, based at least in part on the first sensor data and/or the second sensor data, that multiple identifiers associated with an item are visible. For example, the sensor data may include image data that has multiple identifiers or bar codes that may be read by the system and compared to each other to determine that the two or more identifiers differ.

At 910, the system may determine a correct identifier for the item. For example, the system may classify the item using one or more machine learned models. The system may also compare the multiple detected identifiers to identifiers on an order list to see if one or more of the identifiers match an expected item. If multiple identifiers match the order list the system may utilize the machine learned models to classify the item. In some cases, the machine learned models may also receive one or more item models associated with the identifiers matching the order list.

At 912, the system may determine a size of a new label for the item and at, 914, the system may cause the new label to print. For example, the system may determine a size of the label based on a size of the one or more labels and/or a bounding box applied to the one or more existing labels. In some cases, the system may generate multiple new labels, such as when the existing labels are on different surfaces of the item and/or greater than or equal to a distance threshold. For instance, if a bounding box associated with one or more first existing labels is greater than or equal to a distance threshold from a bounding box associated with one or more second existing labels, the system may define a size and print two labels, one associated with the one or more first existing labels and one associated with the one or more second labels.

At 916, the system may provide a visual indication of the item and a location of the item with respect to the order cart and instructions to place the new label over the multiple identifiers. For example, the system may cause a visual indication or model of the cart and/or item to be displayed on a display device associated with the audit area and/or a user device associated with the cart operator. The system may, in some cases, capture third sensor data as the operator places the new labels on the item. In this manner, the system may cause new labels to be placed in a manner to prevent an inadvertent scanning of one of the incorrect existing identifiers.

In some cases, the system may also request the operator place the item at a specified location away from the cart and/or to hold and rotate the item so that the system may ensure no additional existing labels are present prior to indicating to the operator to proceed with shipping the items.

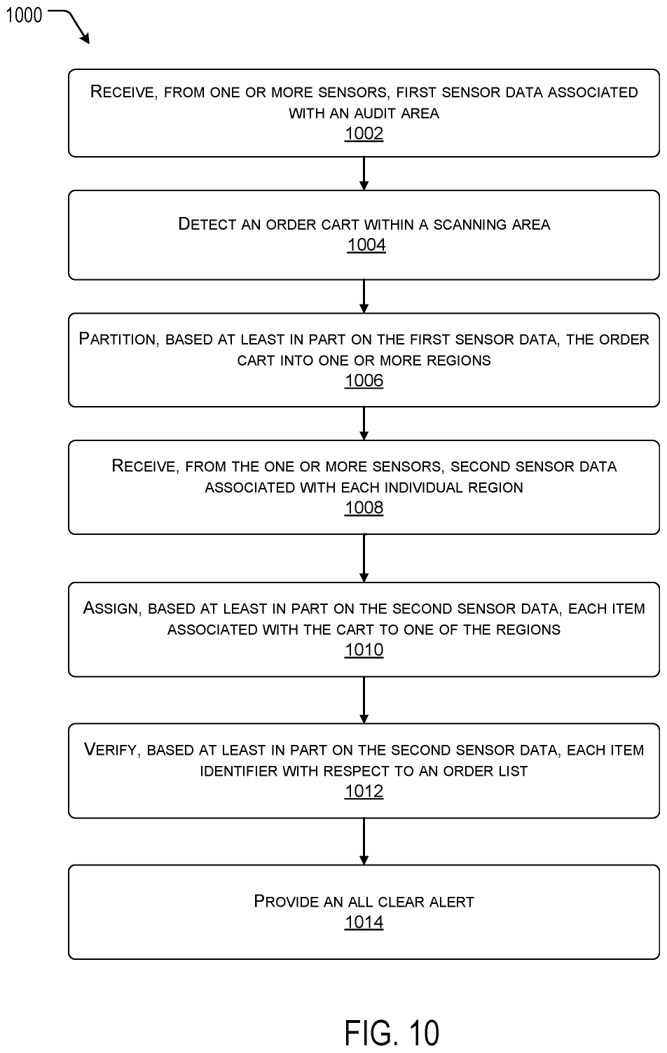

FIG. 10 is another flow diagram illustrating an example process 900 associated with auditing an order cart, according to some implementations. In some cases, the system may be configured to capture sensor data associated with the order cart in parts. For instance, the system may partition the cart into discretized regions and cause the sensors to capture sensor data (such as zoomed sensor data) associated with each region.

At 1002, the system may receive, from one or more sensors, first sensor data associated with an audit area. For example, the sensor data may be image data of an order cart and/or the individual items currently located on the order cart that is placed within the audit area. In some cases, the sensor data may include depth data, weight data (e.g., a floor sensor detecting the weight of the order cart), contact data (e.g., a wheel of a cart contacting a floor sensor).

At 1004, the system may detect an order cart within a scanning area. For example, the system may utilize the first sensor data to determine that a cart is present in the audit area.

At 1006, the system may partition, based at least in part on the first sensor data, the order cart into one or more regions. For example, the regions may be predefined based on a stored model of the order cart and/or determined dynamically based on determined characteristics of the cart, determined characteristics of the items, expected characteristics of the items (e.g., expected characteristics from the order list), and/or arrangements of the items with respect to each other and/or the order cart.

At 1008, the system may receive, from the one or more sensors, second sensor data associated with each individual region. In one example, the second sensor data may be image data captured by one or more sensors for each region, such as by panning, tilting, and zooming the one or more sensors, as discussed above.

At 1010, the system may assign, based at least in part on the second sensor data, each item associated with the cart to one of the regions. For example, if an item is present in two or more regions, the system may assign the item to one of the two regions based on, for example, an amount of the item associated with each region, the location of the label or identifier, an amount of a label or identifier within each region, and the like.

At 1012, the system may verify each item identifier with respect to an order list. For example, the system may compare each detected identifier with an expected identifier on the order list associated with the order cart. In some cases, the system may utilize a detected identifier on the order cart to select the order list from a plurality of orders being filled by facility operators and/or systems.

At 1014, the system may provide an all clear alert to the operator. For example, the system may verify each of the items with the order list and if the order is complete and correct (e.g., no missing items, no additional items, and all items have a correct label or identifier), the system may provide to a user device associated with the operator of the order cart and/or display associated with the audit area a notification or alert that the operator may proceed to load the items onto a transport vehicle for delivery.

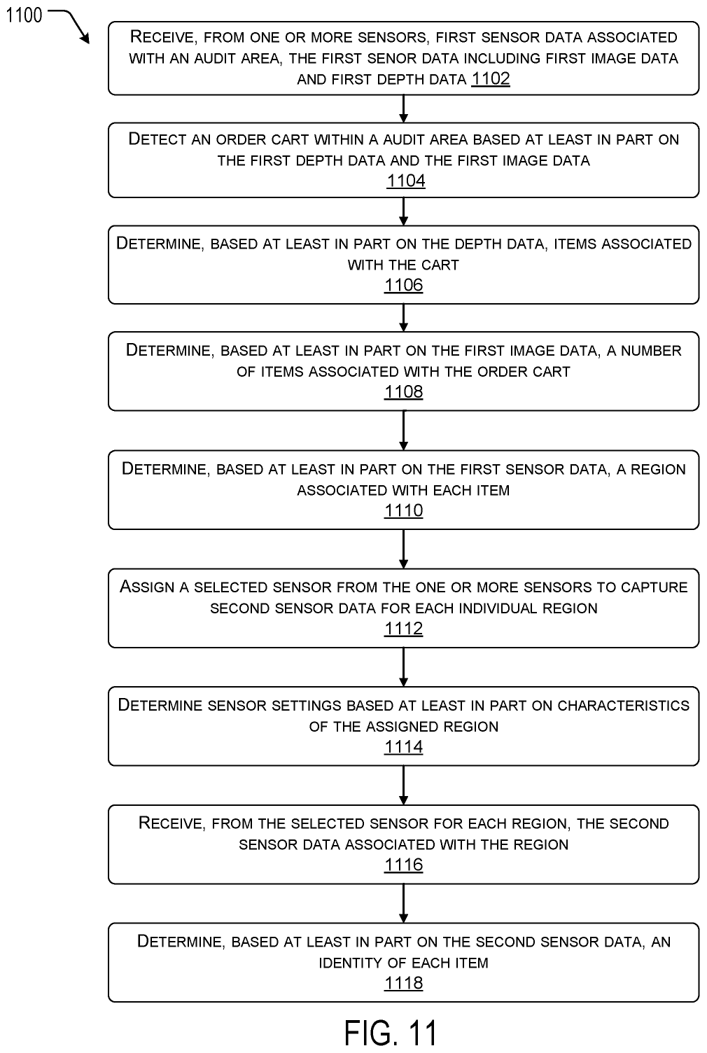

FIG. 11 is another flow diagram illustrating an example process 1100 associated with auditing an order cart, according to some implementations. In this example, the system may utilize multiple sensors, such as pan tilt zoom (PTZ) cameras to determine the identity of each item associated with an order cart.

At 1102, the system may receive, from one or more sensors, first sensor data associated with an audit area, the first sensor data including first image data and first depth data.

At 1104, the system may detect an order cart within the audit area based at least in part on the first depth data and the first image data. for example, the system may detect a change between the first depth data and an expected depth or the like. in other cases, the system may segment and/or classify the image data and detect the order cart within the segmented/classified data.

At 1106, the system may determine, based at least in part on the depth data, items associated with the cart. For example, the depth data may represented a number of items associated with the order cart and at least one additional item that is associated with the background, such as on a shelf, being carried by a facility operator, associated with a second order cart awaiting entry into or exiting the audit area, a second order cart in proximity to the audit area or the like. Thus, the system may utilize the depth data associated with the order cart and the depth data associated with each identified, segmented, and/or classified item to determine if the item is associated with or belongs to the set of items belonging to the cart.

At 1108, the system may determine, based at least in part on the first image data, a number of items belonging to the cart. For example, the system may segment the image data that corresponds to items having depth data associated with the cart into a number of distinct items or regions. The system may then number or assign codes to each of the distinct items. In some case, the number assigned to each item may be ordered, such as numerically or alphabetically. In some cases, the system may also utilize the first sensor data to determine an orientation of each item (or package of items) on the cart. For example, the system may utilize one or more models, such as machine learned models, to determine the orientation of individual item. The system may then utilize the orientation in assisting with determining or understanding correlations of labels or label data to items.

At 1110, the system may determine a region associated with each item. For example, the numbered items may be assigned bounding boxes that may defined an associated region. The regions may be adjacent to one or more other regions in a pattern that is discernable to the system based on the numbering assigned to the items. In some cases, a size, depth, and other characteristics of each region may be determined. In some examples, the system may determine a region within a first local coordinate associated with the first sensor and/or the first sensor data. The system may then covert the first local coordinates to a world or global coordinate system. Then the system may covert the global coordinates into a second local coordinates associated with the second sensor or second senor data assigned to capture the second sensor data of the specific region. For example, the system may utilize known distances, parameters between sensor positions in the physical environment as well as sensor settings or characteristics to covert between coordinate systems. In some cases, the system my utilize pixel counting and overlapping sensor data (such as image data). the system may also use projections, projection errors, scaling factors, and the like to covert between the coordinate systems.

At 1112, the system may assign a selected sensor of the one or more sensors to capture second senor data for each individual region. For example, the one or more sensors may include four PTZ cameras in addition to at least one depth camera. The system may assign each of the regions to one of the PTZ cameras. The system may assign the regions based on the proximity to each other, the intrinsic properties of the PTZ cameras (e.g., shutter speed, zoom speed, tilt speed, and the like), a current field of view (e.g., zoom, position, and the like) of the PTZ cameras, and/or the determined characteristics of each region. For example, the system may attempt to optimize the total capture time associated with the second sensor data. in this manner, each PTZ camera may be assigned to a number of regions with an order of capture. The assigned regions and order may be selected or determined by the system to reduce changes in focus (e.g., similar depth regions are assigned to the same PTZ camera), positions (proximate regions are assigned to the same PTZ camera), reduce change in zoom (e.g., similarly size regions may be assigned ot the same PTZ camera), and the like. It should be understood that in some cases, the number of regions assigned to each PTZ camera may differ based on the for instance arrangement of the items, size of the items, current settings/characteristics of the PTZ cameras and the like. For instance, one of the PTZ may be used to capture the first senor data and may be further out of focus than the remaining PTZ camera and, thereby, the system may assign fewer regions as the initial focusing and zooming may be more costly in terms of time than the other regions. In some cases, the region or setting of each camera when capturing the zoomed in or item specific sensor data may be determined based at least in part on the orientation data of the individual items.

At 1114, the system may determine sensor settings based at least in part on characteristics of the assigned regions. For example, the determined characteristics of each region may be used to manually focus, zoom, and tilt the camera opposed to using built in auto-focus and auto-zoom features. For example, using the depth data and the bounding box of the region the system may supply values for setting the focus, zoom, or position of the camera without using any internal calibration features of the camera itself. By manually supplying the values, the total capture time associated with the second sensor data may be further reduced.

At 1116, the system may receive, from the selected sensor for each region, the second senor data associated with the region and, at 1118, the system may determine, based at least in part on the second sensor data, an identify of each item. For example, the second sensor data may be configured to be at a zoom in which the identifiers on the item may more easily be determined than using the original first image data.

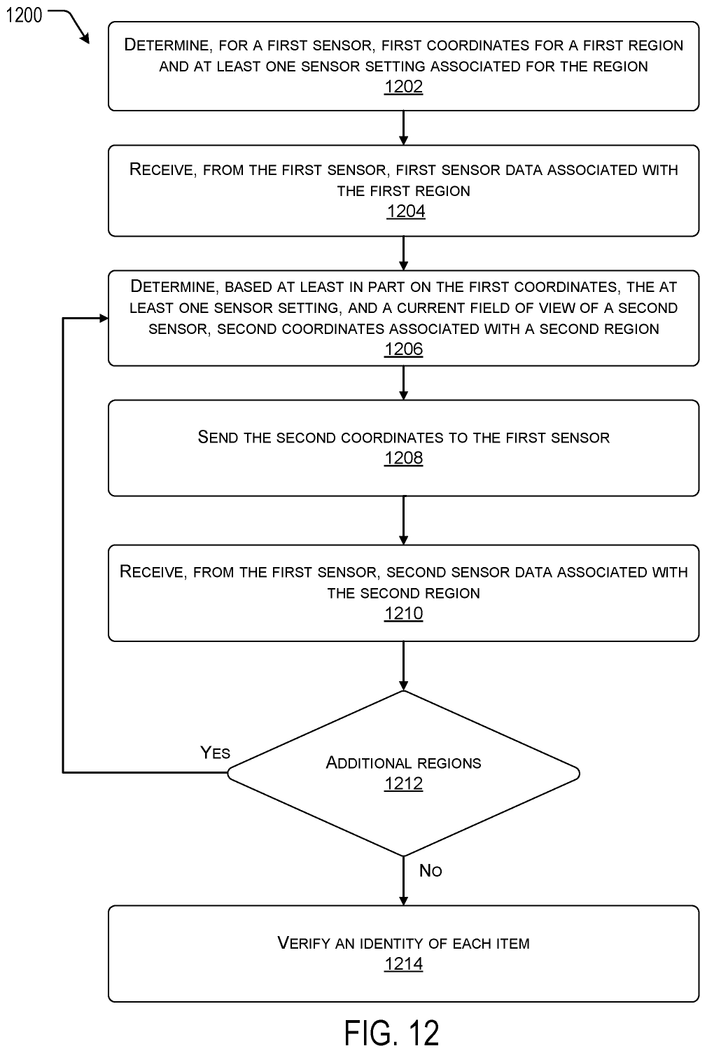

FIG. 12 is another flow diagram illustrating an example process 1200 associated with auditing an order cart, according to some implementations. In this example, the system may utilize multiple sensors, such as PTZ cameras to determine the identity of each item associated with an order cart.

At 1202, the system may determine for a first sensor, first coordinates for a first region and at least one sensor setting associated with the region. For example, system may utilize characteristics of each region to manually control he settings of the camera opposed to using built in auto-focus and auto-zoom features. For example, using the depth data and the bounding box of the region the system may supply values for setting the focus, zoom, or position of the camera without using any internal calibration features of the camera itself. By manually supplying the values, the total capture time associated with the second sensor data may be further reduced.

At 1204, the system may receive, from the first sensor, first senor data associated with the first region. For example, the first sensor data may be image data associated with the first region based on the settings or setting values supplied to the first sensor. In some cases, the system may utilize the first sensor data to determine the identity of the first item within the first region.

At 1206, the system may determine, based at least in part on the first coordinates, the at least one sensor setting, and a current field of view of a second sensor, second coordinates associated with a second region for the first sensor. For example, the system may assign the regions based on the proximity to each other, the intrinsic properties or the field of view of the first sensor and/or the second senor cameras, and/or the characteristics of a current region and a second region (e.g. a similar depth or the like). For example, the system may attempt to optimize the total capture time associated with the sensor data over the set of regions, as discussed above.

At 1208, the system may send the second coordinate sot the first sensor and, at 1210, the system may receive, from the first sensor, second sensor data associated with the second region. The system may then, at 1212, determine if additional regions are yet to be scanned. If there are additional regions, the process 1200 returns to 1206. Otherwise, the process proceeds to 1214.

At 1214, the system may verify an identity of each item using the captured sensor data. For example, the system may determine the identity of the item based on captured label data associated with the region as discussed herein.

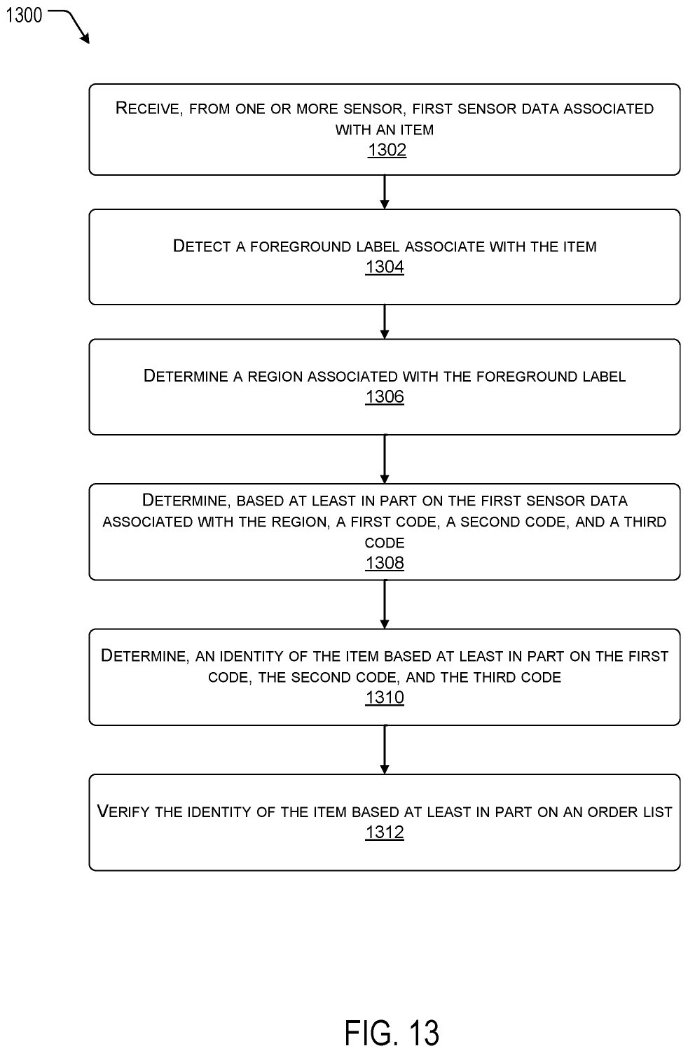

FIG. 13 is another flow diagram illustrating an example process 1300 associated with auditing an order cart, according to some implementations. As discussed herein, the system may receive sensor data, such as image data, associated with each region or each item detected on the order cart. The system may then determine or verify the identity of the item using the sensor data.

At 1302, the system may receive, from one or more sensor, first sensor data associated with an item. For example, the system may receive the first sensor data associated with a region or bounding box associated with the item. The first sensor data may be at a desired zoom or such that one or more codes, content, text, or the like are machine readable in a reliable fashion. For instance, the first senor data may be at a zoom equal to or greater than a zoom threshold based on prior captured depth data associated with the item.

At 1304, the system may detect a foreground label associated with the item. For example, the system may determine based on the first sensor data a foreground label from a set of one or more labels applied to the items.

At 1306, the system may a region associated with the foreground label. For example, the system may determine region or bounding box associated with the foreground label. It should be understood that the region may be less than a region assigned to the item, such as a region substantially comprised by the label.

At 1308, the system may determine, based at least in part on the first senor data associated with the region, a first code, a second code and a third code. For instance, in the illustrated example, the labels may include a set of three identifiers comprising a UPC and two ITF codes.

At 1310, the system may determine, an identity of the item based at least in part on the first code, the second code, and the third code. For example, the system may be able to verify the identity if one or more of the codes are damage or otherwise unreadable by confirming or cross validating readable portions of one or more of the three codes with each other.

At 1312, the system may verify the identity of the item based at least in part on an order list. For example, the system may compare each detected identifier with an expected identifier on the order list associated with the order cart. In some cases, the system may utilize a detected identifier on the order cart to select the order list from a plurality of orders being filled by facility operators and/or systems.

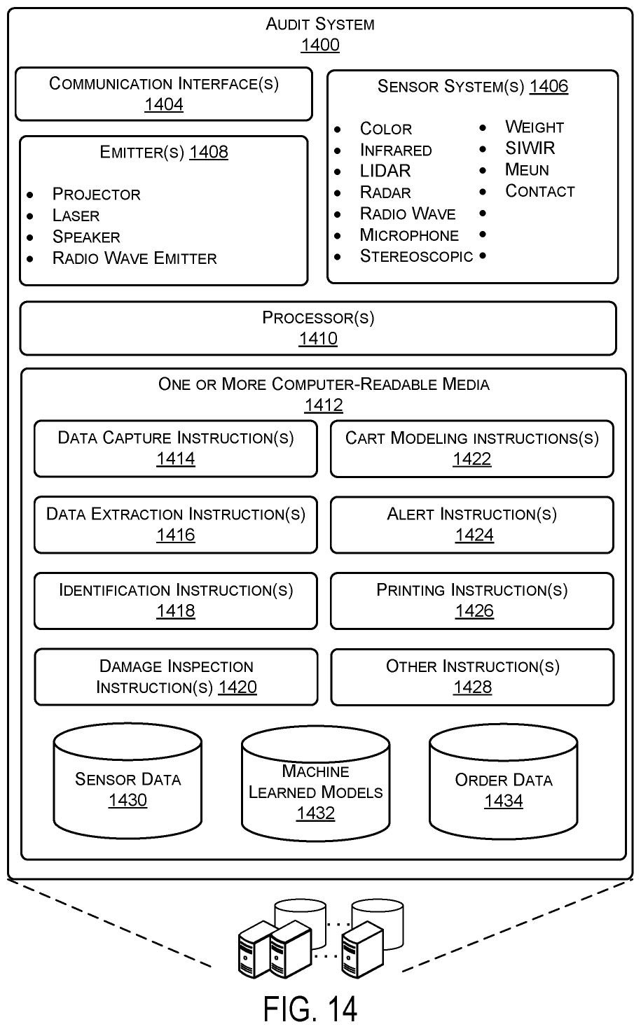

FIG. 14 is an example audit system that may implement the techniques described herein according to some implementations. The system 1400 may include one or more communication interface(s) 1404 (also referred to as communication devices and/or modems), one or more sensor system(s) 1406, and one or more emitter(s) 1408.

The system 1400 can include one or more communication interfaces(s) 1404 that enable communication between the system 1400 and one or more other local or remote computing device(s) or remote services, such as a cloud-based service of FIG. 2. For instance, the communication interface(s) 1404 can facilitate communication with other proximate sensor systems and/or other facility systems. The communications interfaces(s) 1404 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The one or more sensor system(s) 1406 may be configured to capture the sensor data 1430 associated with an order cart. In at least some examples, the sensor system(s) 1406 may include thermal sensors, time-of-flight sensors, location sensors, LIDAR sensors, SIWIR sensors, radar sensors, sonar sensors, infrared sensors, cameras (e.g., RGB, IR, intensity, depth, etc.), Muon sensors, microphone sensors, environmental sensors (e.g., temperature sensors, humidity sensors, light sensors, pressure sensors, etc.), and the like. In some examples, the sensor system(s) 1006 may include multiple instances of each type of sensors. For instance, camera sensors may include multiple cameras disposed at various locations.

The system 1400 may also include one or more emitter(s) 1008 for emitting light and/or sound. By way of example and not limitation, the emitters in this example include light, illuminators, lasers, patterns, such as an array of light, audio emitters, and the like.

The system 1400 may include one or more processors 1410 and one or more computer-readable media 1412. Each of the processors 1410 may itself comprise one or more processors or processing cores. The computer-readable media 1412 is illustrated as including memory/storage. The computer-readable media 1412 may include volatile media (such as random access memory (RAM)) and/or nonvolatile media (such as read only memory (ROM), Flash memory, optical disks, magnetic disks, and so forth). The computer-readable media 1412 may include fixed media (e.g., RAM, ROM, a fixed hard drive, and so on) as well as removable media (e.g., Flash memory, a removable hard drive, an optical disc, and so forth). The computer-readable media 1412 may be configured in a variety of other ways as further described below.

Several modules such as instructions, data stores, and so forth may be stored within the computer-readable media 1412 and configured to execute on the processors 1410. For example, as illustrated, the computer-readable media 1412 stores data capture instructions 1414, data extraction instructions 1416, identification instructions 1418, damage inspection instructions 1420, cart modeling instructions 1422, alert instruction 1424, printing instructions 1426, as well as other instructions 1428, such as an operating system. The computer-readable media 1412 may also be configured to store data, such as sensor data 1430, machine learned models 1432, and order data 1434, as well as other data.

The data capture instructions 1414 may be configured to extract image data or other sensor data representing an order cart. For instance, when an order cart is detect entering, traversing, or position within an order cart audit area, the data capture instructions 1414 may be cause the senor system 1406 to control (e.g., adjust parameters, zoom, tilt, pan, or otherwise adjust the sensors) to capture the sensor data 1420 associated with the detected order cart. In some cases, the parameters may be based on the dimensions, size, identity, number of items, current stacking arrangement, or the like.

The data extraction instructions 1416 may be configured to determine features associated each item on the order cart based at least in part on the sensor data 1430 captured according to the data capture instructions 1414. For example, the extraction instructions 1416 may determine the a size, dimensions, orientation, or the like associated with each item.

The identification instructions 1418 may be configured to determine an identity of each item on the order cart based at least in part on the sensor data 1430 and the features identified by the data extraction instructions 1416. For example, the identification instructions 1418 may determine an identity of an item based at least in part on the size, the dimensions, a detected bar code or other identifier, relative position (e.g., stack on top), implied pick order (e.g., top items are picked later than bottom items) or the like. The identification instructions 1418 may also utilize a list of known item or the order list to determine the identity of each item.

The damage inspection instructions 1420 may be configured to determine if one or more of the items are damaged, such as based at least in part on the sensor data 1430 and/or the features identified by the data extraction instructions 1416, such as a dimensions that does not match any item on the order list.

The cart modeling instructions 1422 may be configured to generate a 3D model of the cart that may be displayed to, for instance, an audit operator or facility operator to review. In this manner, the operator may be able to double check or confirm that all items are present on the cart.

The alert instruction 1424 may be configure to generate an alert if one or more items are not identified, missing, or additional. Similarly, the alert instruction 1424 may be configure to generate an alert if one or more items appear to be damaged. In some cases, the alerts may be a message to a device associated with one or more operators.

The printing instructions 1426 may cause a report or forms to be printed when the items on the order cart are confirmed, identified, and approved (e.g., free of damage). The report or from may then be provide to a transit personal such as the operator of the vehicle picking up the items for shipping.

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

### EXAMPLE CLAUSES

A. A method comprising: receiving first sensor data associated with an order cart; determining, based at least in part on the first sensor data, an identity of an item physically located on the order cart; determining, based at least in part on the identity, that the item is associated with an order corresponding to the order cart; responsive to determining that the item is associated with the order, determining that the order is complete; and alerting a facility operator that the order may be loaded on a transport.

B. The method of claim A, wherein determining that the item is associated with the order corresponding to the order cart is based at least in part on an order list associated with the order cart.

C. The method of claim A, wherein determining the identity of the item is based at least in part on pixel of the sensor data associated with the item.

D. The method of claim A, wherein the item is a first item and determining the identity of the first item is based at least in part second sensor data representative of a second item adjacent to the first item on the order cart.

E. The method of claim A, further comprising: determining, based at least in part on the sensor data, that the item is damaged; and responsive to determining the first item is damaged, causing an alert to be sent to a device associated with a facility operator.

F. The method of claim A, wherein the first sensor data including data associated with two or more image devices.

G. The method of claim A, wherein: receiving the first sensor data associated with an order cart further comprises: partitioning the order cart into two or more discretized regions; causing the sensor to capture regionalized sensor data associated with individual regions of the two or more discretized regions; determining that the item is represented in the regionalized sensor data associated with a first discretized region of the two or more discretized regions and the regionalized sensor data associated with a second discretized region of the two or more discretized regions; assigning the item to the first discretized region; and determining the identity of the item physically located on the order cart is based at least in part on the regionalized sensor data associated with the first discretized region.

H. The method of claim A, further comprising responsive to determining, based at least in part on the first sensor data, that a second item is not present on the order cart, alerting a facility operator that the order is incomplete.

I. The method of claim A, wherein determining the identity of the item physically located on the order cart further comprises: determining, based at least in part on the first sensor data, that the item includes a first identifier and a second identifier; determining that the first identifier differs from the second identifier; and determining, based at least in part on the sensor data, a correct identifier for the item; causing a label including the correct identifier to print; and sending a visual indication of the item, a location relative to the order cart associated with the item, and instructions to place the label on the item to a display.

J. The method of claim A, further comprising: responsive to detecting an order cart within a scanning area, causing one or more sensors to capture the sensor data.

K. The method of claim J, further comprising determining, based at least in part on the sensor data, an identity of the order cart and accessing an order list associated with the order cart.

L. A system comprising: one or more processors; and one or more non-transitory computer-readable media storing instructions that, when executed by the one or more processors, cause the one or more processors to perform operations comprising: determining an identity of an item physically located on the order cart; determining, based at least in part on the identity, that the item is associated with an order corresponding to the order cart; determining that the order is complete; and alerting a facility operator that the item may be loaded on a transport.

M. The system of claim L, wherein the operations further comprise: accessing image data associated with the order cart, the image data captured by two or more image device; and wherein determining the identity of the item is based at least in part on the sensor data.

N. The system of claim M, wherein the operations further comprise: determining, based at least in part on the image data, that the item includes a first identifier and a second identifier; determining that the first identifier differs from the second identifier; and determining, based at least in part on the image data, a correct identifier for the item; causing a label including the correct identifier to print; and sending a visual indication of the item, a location relative to the order cart associated with the item, and instructions to place the label on the item to a display.

O. The system of claim N, wherein the first identifier is the correct identifier.

P. The system of claim L, wherein the operations further comprise: partitioning the order cart into two or more discretized regions; causing an image device to capture regionalized image data associated with individual regions of the two or more discretized regions; and wherein determining the identity of the item is based at least in part on the regionalized image data.

Q. One or more non-transitory computer-readable media storing instructions that, when executed by one or more processors, cause the one or more processors to perform operations comprising: causing a sensor to capture first sensor data associated with an order cart; determining, based at least in part on the first sensor data, an identity of an item physically located on the order cart; determining, based at least in part on the identity, that the item is associated with an order corresponding to the order cart; and responsive to determining that the item is associated with the order, determining that the order is complete.

R. The one or more non-transitory computer-readable media of claim Q, wherein the operations further comprise alerting a facility operator that the order may be loaded on a transport.

S. The one or more non-transitory computer-readable media of claim Q, wherein the operations further comprise: determining, based at least in part on the sensor data, that the item is damaged; and responsive to determining the first item is damaged, causing an alert to be sent to a device associated with a facility operator.

T. The one or more non-transitory computer-readable media of claim Q, wherein determining the identity of the item physically located on the order cart further comprises: determining, based at least in part on the first sensor data, that the item includes a first identifier and a second identifier; determining that the first identifier differs from the second identifier; and determining, based at least in part on the sensor data, a correct identifier for the item; causing a label including the correct identifier to print; and sending a visual indication of the item, a location relative to the order cart associated with the item, and instructions to place the label on the item to a display.

While the example clauses described above are described with respect to one particular implementation, it should be understood that, in the context of this document, the content of the example clauses can also be implemented via a method, device, system, a computer-readable medium, and/or another implementation. Additionally, any of examples may be implemented alone or in combination with any other one or more of the other examples.

What is claimed is:

1. A method comprising:
receiving first sensor data associated with an order cart;
determining, based at least in part on the first sensor data, an identity of an item physically located on the order cart;
determining, based at least in part on the identity, that the item is associated with an order corresponding to the order cart;
responsive to determining that the item is associated with the order, determining that the order is complete; and
alerting a facility operator that the order may be loaded on a transport.

2. The method of claim 1, wherein determining that the item is associated with the order corresponding to the order cart is based at least in part on an order list associated with the order cart.

3. The method of claim 1, wherein determining the identity of the item is based at least in part on pixel of the sensor data associated with the item.

4. The method of claim 1, wherein the item is a first item and determining the identity of the first item is based at least in part second sensor data representative of a second item adjacent to the first item on the order cart.

5. The method of claim 1, further comprising:
determining, based at least in part on the sensor data, that the item is damaged; and
responsive to determining the item is damaged, causing an alert to be sent to a device associated with a facility operator.

6. The method of claim 1, wherein the first sensor data including data associated with two or more image devices.

7. The method of claim 1, wherein:
receiving the first sensor data associated with an order cart further comprises:
partitioning the order cart into two or more discretized regions;
causing the sensor to capture regionalized sensor data associated with individual regions of the two or more discretized regions;
determining that the item is represented in the regionalized sensor data associated with a first discretized region of the two or more discretized regions and the regionalized sensor data associated with a second discretized region of the two or more discretized regions; and
assigning the item to the first discretized region; and
determining the identity of the item physically located on the order cart is based at least in part on the regionalized sensor data associated with the first discretized region.

8. The method of claim 1, further comprising responsive to determining, based at least in part on the first sensor data, that a second item is not present on the order cart, alerting a facility operator that the order is incomplete.

9. The method of claim 1, wherein determining the identity of the item physically located on the order cart further comprises:
determining, based at least in part on the first sensor data, that the item includes a first identifier and a second identifier;
determining that the first identifier differs from the second identifier; and
determining, based at least in part on the sensor data, a correct identifier for the item;
causing a label including the correct identifier to print; and
sending a visual indication of the item, a location relative to the order cart associated with the item, and instructions to place the label on the item to a display.

10. The method of claim 1, further comprising:
responsive to detecting an order cart within a scanning area, causing one or more sensors to capture the sensor data.

11. The method of claim 10, further comprising determining, based at least in part on the sensor data, an identity of the order cart and accessing an order list associated with the order cart.

12. A system comprising:
one or more processors; and
one or more non-transitory computer-readable media storing instructions that, when executed by the one or more processors, cause the one or more processors to perform operations comprising:
determining an identity of an item physically located on an order cart;
determining, based at least in part on the identity, that the item is associated with an order corresponding to the order cart;
determining that the order is complete; and
alerting a facility operator that the item may be loaded on a transport.

13. The system of claim 12, wherein the operations further comprise:
accessing image data associated with the order cart, the image data captured by two or more image device; and
wherein determining the identity of the item is based at least in part on the image data.

14. The system of claim 13, wherein the operations further comprise:
determining, based at least in part on the image data, that the item includes a first identifier and a second identifier;
determining that the first identifier differs from the second identifier; and
determining, based at least in part on the image data, a correct identifier for the item;
causing a label including the correct identifier to print; and
sending a visual indication of the item, a location relative to the order cart associated with the item, and instructions to place the label on the item to a display.

15. The system of claim 14, wherein the first identifier is the correct identifier.

16. The system of claim 12, wherein the operations further comprise:
partitioning the order cart into two or more discretized regions;
causing an image device to capture regionalized image data associated with individual regions of the two or more discretized regions; and
wherein determining the identity of the item is based at least in part on the regionalized image data.

17. One or more non-transitory computer-readable media storing instructions that, when executed by one or more processors, cause the one or more processors to perform operations comprising:
causing a sensor to capture first sensor data associated with an order cart;
determining, based at least in part on the first sensor data, an identity of an item physically located on the order cart;
determining, based at least in part on the identity, that the item is associated with an order corresponding to the order cart; and
responsive to determining that the item is associated with the order, determining that the order is complete.

18. The one or more non-transitory computer-readable media of claim 17, wherein the operations further comprise alerting a facility operator that the order may be loaded on a transport.

19. The one or more non-transitory computer-readable media of claim 17, wherein the operations further comprise:
determining, based at least in part on the sensor data, that the item is damaged; and
responsive to determining the item is damaged, causing an alert to be sent to a device associated with a facility operator.

20. The one or more non-transitory computer-readable media of claim 17, wherein determining the identity of the item physically located on the order cart further comprises:
determining, based at least in part on the first sensor data, that the item includes a first identifier and a second identifier;
determining that the first identifier differs from the second identifier; and
determining, based at least in part on the sensor data, a correct identifier for the item;
causing a label including the correct identifier to print; and
sending a visual indication of the item, a location relative to the order cart associated with the item, and instructions to place the label on the item to a display.
